(19) United States
(12) Patent Application Publication
(10) Pub. No.: US 2011/0197453 A1
(43) Pub. Date: Aug. 18, 2011

(54) Infant feeding device and method

(76) Inventor: Andrea Hultgreen, Blue Springs, MO (US)

(21) Appl. No.: 12/931,893

(22) Filed: Feb. 14, 2011

Related U.S. Application Data
(60) Provisional application No. 61/338,281, filed on Feb. 17, 2010.

(51) Int. Cl. A47J 43/28

(52) U.S. Cl. 30/141

(57) ABSTRACT

A feeding device including a compressible handle connected to a tube for aspirating and dispensing food to infants. A spoon like bowl at an end of the device opposite the handle and wherein at least a portion of the tube is beneath the bowl and the tube is in a portion supporting the bowl and includes a tube opening for dispensing food beneath the bowl.

The device includes guides to measure the amount of food dispensed by the device such that the amount of food taken in by an infant can be accurately tracked.

### RELATED APPLICATIONS

This application claims benefit under 35 USC 119 of provisional patent application 61/338,281, Infant feeding device and method, filed Feb. 17, 2010.

### BACKGROUND OF THE INVENTION

It is sometimes necessary to provide extra care for infants having trouble eating. It is common for children that are born prematurely or that have developmental disability or that have oral aversions and have trouble learning to eat. It is common practice to spoon feed or tube feed these infants.

It is important to monitor the food intake for infants to make sure they are taking the needed nutrition. Because spoon feeding is messy it is difficult to accurately measure the food that is actually consumed by the infant. It is also difficult to encourage the infant to learn feeding skills using tube or spoon feeding.

Thus it can be seen that there is a need for improved apparatus and method to feed infants.

### SUMMARY OF THE INVENTION

The present invention provides a feeding device for use in feeding infants including; a compressible handle connected to a tube for aspirating and dispensing food, and a bowl at an end of said device opposite said handle. Wherein the tube is beneath the bowl and includes a tube opening under said bowl and adjacent a front edge of the bowl for dispensing food into the mouth of an infant.

### BRIEF DESCRIPTION OF THE DRAWINGS

FIG. 1 shows a cut away side view of the device;

FIG. 2 shows a view of the device in use.

### DETAILED DESCRIPTION OF THE DEVICE

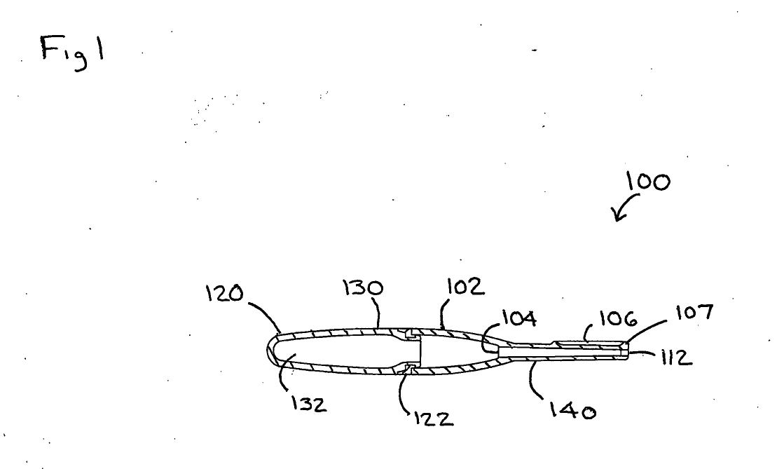

FIG. 1 shows a view of the feeding device 100. The feeding device 100 includes a rigid body 102 that can be molded plastic for example. The body 102 includes a tube 104 and a spoon like bowl 106 having a raised lip 107 surrounding the bowl. The tube 104 includes at least a portion under the bowl 106 and a tip opening 112 at the front edge of the device 100 and at the front edge of the bowl 106. The feeding device 100 includes a flexible compressible bulb handle portion 120 and a seal portion 122 between the bulb 120 and rigid body 102.

The flexible bulb portion 120 and rigid body 102 fit together at the seal 122 to form an ergonomic outer grip surface 130 and in interior cavity 132. The tube 104 can be tapered from a wide opening end in the cavity 132 to a narrow opening tip 112 under the bowl 106. The tube 104 is located in a neck portion 140 of the rigid body 102.

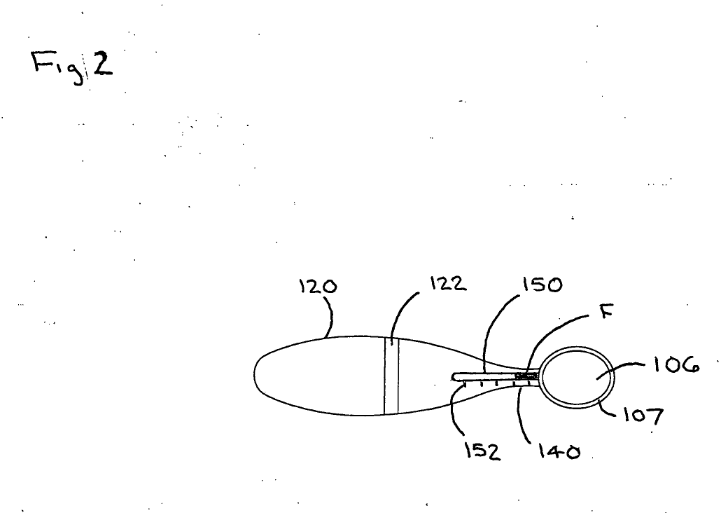

FIG. 2 shows a plan view of the device 100. The neck portion 140 is thin and can be at least partially transparent or include a window such that food drawn into the tube 104 can be measured by measurement guides 152 on the neck 140. By means of the guides 152 a person using the device 100 can measure the amount of food introduced.

FIG. 2 shows an external view of the device 100 in use. FIG. 2 shows that the seal 122 forms a band around the device 100. The neck 140 can include a transparent window 150 with guide marks 152 that can be used to measure either medicine or food F dispensed.

The purpose of the device 100 is to introduce a baby or infant to solid food. In use, first the flexible bulb portion 120 is compressed to reduce the volume of cavity 132 to create a suction. The tip opening 112 of the device 100 is then placed into a source of food or medicine and the flexible bulb portion 120 is at least partially released so that food is suctioned into the tube 104. Solid food introduced using this device 100 is often in the form of a paste. The tube 104 is tapered making it easier to draw food in and to later dispense it. The device 100 can be used in two methods. One method is to draw food or medicine into the tube 104 and to measure the food or medicine and then dispense it to the infant. A second method is to draw food into the tube 104 and place some food into the spoon like bowl 106. In this mode the baby then gets food from the tube 104 but also sees the food F delivered in the bowl 106 so that the baby can build the association of the spoon like bowl 106. In either mode the baby will build an association between the spoon and food. The association teaches the baby the feel of the spoon and allows for measuring. Typically this device 100 would be used with infants around 3 months of age and would be ideal as a tool to begin introducing solid foods.

1. A feeding device for use in feeding including;
a compressible handle connected to a tube for aspirating and dispensing food,
a bowl at an end of said device opposite said handle and wherein at least a portion of said tube is beneath said bowl and includes a tube opening for dispensing food into the mouth.

2. The feeding device of claim 1 wherein said tube is tapered from a smallest cross sectional area at said opening to a larger cross sectional area adjacent said handle.

3. The feeding device of claim 1 wherein said bowl is carried on a rigid body and wherein a seal forms a band between said handle and said rigid body.

4. The feeding device of claim 1 wherein said device includes indicia to measure the amount of food in said tube.

5. A feeding device for use in feeding infants including;
a compressible handle connected to a tube for aspirating and dispensing food,
a bowl at an end of said device opposite said handle and wherein said tube is beneath said bowl and said tube is in a neck portion supporting said bowl and includes a tube opening for dispensing food beneath said bowl.

6. The feeding device of claim 5 wherein said bowl is carried on a rigid body that includes said neck portion and wherein a seal forms a band between said handle and said rigid body.

7. The feeding device of claim 6 wherein said tube is tapered from a smallest cross sectional area at said opening to a larger cross sectional area adjacent said handle.

8. The feeding device of claim 7 wherein said device includes guides to measure the amount of food dispensed by said tube.

9. A feeding device including;
a compressible handle connected to a tube for aspirating and dispensing food,
a bowl at an end of said device opposite said handle and wherein at least a portion of said tube is beneath said bowl and said tube is in a portion supporting said bowl and includes a tube opening for dispensing food beneath said bowl.

10. The feeding device of claim 9 wherein said device includes guides to measure the amount of food dispensed by said device.

11. The feeding device of claim 9 wherein said tube is tapered from a smallest cross sectional area at said opening to a larger cross sectional area adjacent said handle.

12. The feeding device of claim 11 wherein said bowl is carried on a rigid body that includes said portion supporting said bowl and wherein a seal forms a band between said handle and said rigid body.
